(19) United States
(12) Patent Application Publication
(10) Pub. No.: US 2014/0189129 A1
(43) Pub. Date: Jul. 3, 2014

(54) INFORMATION PROCESSING SYSTEM AND STORAGE APPARATUS

(71) Applicant: FUJITSU LIMITED, Kawasaki-shi (JP)

(72) Inventor: Hironori KAI, Kawasaki (JP)

(73) Assignee: FUJITSU LIMITED, Kawasaki-shi (JP)

(21) Appl. No.: 14/064,773

(22) Filed: Oct. 28, 2013

(30) Foreign Application Priority Data
Dec. 28, 2012 (JP) 2012-288105

(51) Int. Cl. G06F 3/06

(52) U.S. Cl. CPC G06F 3/0647
USPC 709/226

(57) ABSTRACT

An information processing system includes an information processing apparatus and a first and second storage apparatuses. The first storage apparatus receives a first migration command for migrating data from the first storage apparatus to the second storage apparatus, creates inheritance-destination information based on the first migration command, instructs the second storage apparatus to create inheritance-source information based on the first migration command, and performs migration of the data in accordance with the first migration command. The information processing apparatus obtains the inheritance-destination information and the inheritance-source information from at least one of the first storage apparatus and the second storage apparatus, determines whether migration of the data from the first storage apparatus to the second storage apparatus has been performed, and assigns, based on the inheritance-destination information and the inheritance-source information, an access path to the second storage apparatus upon determining that migration of the data has been performed.

### CROSS-REFERENCE TO RELATED APPLICATION

This application is based upon and claims the benefit of priority from the prior Japanese Patent Application No. 2012-288105 filed on Dec. 28, 2012, the entire contents of which are incorporated herein by reference.

### FIELD

The embodiments discussed herein are related to an information processing system and a storage apparatus.

### BACKGROUND

With the advances made in information and communication technology in recent years, a large number of storage apparatuses that are capable of storing a large amount of data have been put into use. Such storage apparatuses involve periodic substitution (replacement and data migration). For example, servers are generally operated for about ten years, whereas storage apparatuses are generally replaced with new products in about five years.

Work for such replacement of storage apparatus involves inheriting an access path name (a name of a path for accessing a storage apparatus from an application program) of a replaced (old) storage apparatus to a replacing (new) storage apparatus while minimizing the time during which a task is suspended (or without suspending a task). Such work is very cumbersome. Such inheritance of access path name is important work in order to enable a new storage apparatus to be used without changing the settings in application programs after replacement of storage apparatus.

A related technique is disclosed in, for example, Japanese Laid-open Patent Publication No. 2007-18455.

In known storage apparatuses, in order to allow a replacing storage apparatus to inherit an access path name of a replaced storage apparatus, for example, the schemes described below have been employed.

In a first scheme, a user manually releases an access path to a migration-source storage apparatus and manually assigns the access path to a migration-destination storage apparatus.

However, the number of task servers connected to one storage apparatus tends to increase. Hence, with this first scheme, when a storage apparatus is replaced, an access path is manually inherited at all task servers connected to the storage apparatus, which involves a significant workload. As the workload increases, the possibility of making a mistake in the work increases and it also takes an enormous of working hours. In recent years, however, since there are demands for reducing the downtime during migration to zero or a minimum, it is not permissible to spend a large amount of time on the work for inheriting access path.

In a second scheme, a predetermined condition for determining whether a storage apparatus has been replaced is defined. When the condition is met, it is interpreted that the storage apparatus has been replaced, and an access path is automatically switched. For example, when the number of logical unit numbers (LUNs) and a slot position of a host bus adaptor (HBA) in a newly recognized storage apparatus is the same as those in a migration-source storage apparatus, it is determined that replacement of storage apparatus has been performed, and an access path assigned to the migration-source storage apparatus is assigned to the migration-destination storage apparatus (that is, the newly recognized storage apparatus).

This scheme, however, has significant restrictions on the system environment. For example, these restrictions include the restriction that the number of volumes in the migration-source storage apparatus and the number of volumes in the migration-destination storage apparatus be the same and the restriction that an HBA slot used before replacement of storage apparatus and an HBA slot used after replacement of storage apparatus be the same. Furthermore, there is also the possibility that the migration-source storage apparatus will be unable to connect continuously after migration, as well as the possibility that it will be automatically interpreted, due to operational error, that replacement of storage apparatus has occurred, resulting that an access path name is changed. It is therefore difficult to flexibly replace a storage apparatus.

In a third scheme, one virtual device is created for a migration-source storage apparatus and a migration-destination storage apparatus, and an access path to the virtual device is used before and after replacement of storage apparatus.

However, when one virtual device is created for a migration-source storage apparatus and a migration-destination storage apparatus, it is difficult to utilize data in the migration-destination storage apparatus in a shared manner after migration. Since cases in which future data migration is taken into account during initial set-up are rare, the third scheme involves work for creating the migration-source storage apparatus and the migration-destination storage apparatus as one virtual device, thus involving suspending a task while this work is performed.

In a fourth scheme, a management server is prepared to switch input/output (I/O) access, issued from another server, from a migration-source storage apparatus to a migration-destination storage apparatus or to issue an instruction for performing processing for the switching.

This scheme, however, involves preparation of a management apparatus for only migration work, thus adding cost and complexity to the system. Users prefer not to prepare such a migration-dedicated apparatus in the system.

### SUMMARY

According to an aspect of the present invention, provided is an information processing system including an information processing apparatus, a first storage apparatus, and a second storage apparatus. The first storage apparatus includes a first processor. The first processor is configured to receive, from the information processing apparatus, a first migration command for migrating data from the first storage apparatus to the second storage apparatus. The first processor is configured to create inheritance-destination information based on the first migration command. The first processor is configured to instruct the second storage apparatus to create inheritance-source information based on the first migration command. The first processor is configured to perform migration of the data in accordance with the first migration command. The information processing apparatus includes a second processor. The second processor is configured to obtain the inheritance-destination information and the inheritance-source information from at least one of the first storage apparatus and the second storage apparatus. The second processor is configured to determine whether migration of the data from the first storage apparatus to the second storage apparatus has been performed. The second processor is configured to assign, based on the inheritance-destination information and the inheritance-source information, an access path to the second storage apparatus upon determining that migration of the data has been performed.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of an information processing system according to a first embodiment;

FIG. 2 is a diagram illustrating a functional configuration of an information processing system according to a first embodiment;

FIG. 3 illustrates exemplary structures of inheritance-information management tables according to a first embodiment;

FIG. 4 illustrates an operation during storage replacement in an information processing system according to a first embodiment;

FIG. 5 illustrates an operation during storage replacement in an information processing system according to a first embodiment;

FIG. 6 illustrates an operation during storage replacement in an information processing system according to a first embodiment;

FIG. 7 illustrates an operation during storage replacement in an information processing system according to a first embodiment;

FIG. 8 illustrates an operation during storage replacement in an information processing system according to a first embodiment;

FIG. 9 is a flowchart illustrating operations of a management server according to an embodiment;

FIG. 10 is a flowchart illustrating operations of storage apparatuses according to a first embodiment; and

FIG. 11 is a flowchart illustrating operations of the task server according to a first embodiment.

### DESCRIPTION OF EMBODIMENTS

A first embodiment will be described below with reference to the accompanying drawings. The first embodiment described below is merely exemplary and illustrative and is not intended to exclude application of various modifications and technologies not explicitly described in the first embodiment. That is to say, the first embodiment may be practiced in various forms (for example, by combining the first embodiment and a modification) without departing from the spirit and scope thereof.

Configuration

First, a description will be given of the hardware configuration of an information processing system 1 according to the first embodiment.

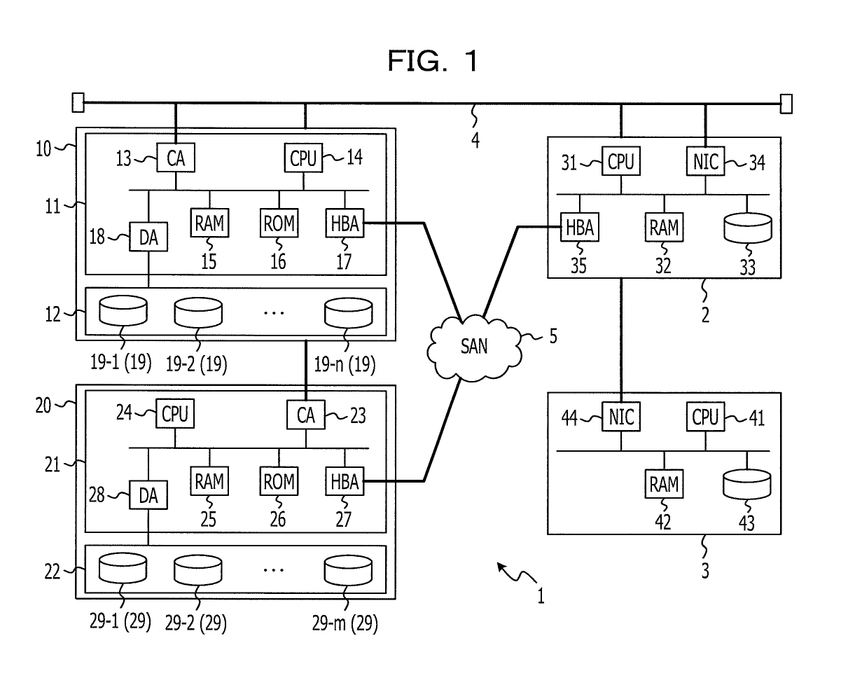

FIG. 1 is a diagram illustrating a hardware configuration of the information processing system 1 according to the first embodiment.

The information processing system 1 includes a task server 2, a management server 3, and storage apparatuses 10 and 20.

In the information processing system 1, the task server 2, the management server 3, and the storage apparatuses 10 and 20 are interconnected, for example, through a link, such as a local area network (LAN) 4. The task server 2 and the storage apparatuses 10 and 20 are also interconnected through a storage area network (SAN) 5.

The task server 2 is, for example, a computer (an information processing apparatus) having a server function and transmits and receives various types of data, such as Small Computer System Interface (SCSI) commands and responses, to and from the storage apparatuses 10 and 20 by using a storage connection protocol. By transmitting disk access commands, such as read/write commands, to the storage apparatuses 10 and 20, the task server 2 writes data to and reads data from storage areas provided by the storage apparatuses 10 and 20.

The task server 2 includes a central processing unit (CPU) 31, a random access memory (RAM) 32, a hard disk drive (HDD) 33, a network interface card (NIC) 34, and a host bus adaptor (HBA) 35.

The CPU 31 is a processing device that performs various types of control and various computational operations. The CPU 31 realizes various functions by executing programs stored in the HDD 33 or a read-only memory (ROM), which is not illustrated, or the like.

The RAM 32 stores therein programs executed by the CPU 31 and various types of data, as well as data resulting from operation of the CPU 31, and so on.

The HDD 33 is a storage device that stores and saves therein various programs, an operating system (OS), and data and operates as an internal disk of the task server 2.

The NIC 34 serves as a communication adapter that connects the task server 2 to, for example, an external network, such as the LAN 4. The NIC 34 is, for example, a LAN card.

The HBA 35 is a storage connection interface that connects to the storage apparatuses 10 and 20 so as to allow communication therewith through the SAN 5. The HBA 35 is, for example, a Fibre Channel interface.

In the present embodiment, the task server 2 obtains inheritance information (including inheritance-source information and inheritance-destination information) of all recognized devices in the storage apparatuses 10 and 20 as part of device recognition processing at the start of operation and stores the obtained inheritance information in association with the recognized devices, as described below.

The management server 3 is an information processing apparatus. An operator who performs installation and maintenance work of the storage apparatuses 10 and 20 performs various types of management work on the storage apparatuses 10 and 20 via the management server 3.

The management server 3 includes a CPU 41, a RAM 42, an HDD 43, and a NIC 44.

The CPU 41 is a processing device that performs various types of control and various computational operations. The CPU 41 realizes various functions by executing programs stored in the HDD 43, a ROM (not illustrated), or the like.

The RAM 42 stores therein programs executed by the CPU 41 and various types of data, as well as data resulting from operation of the CPU 41, and so on.

The HDD 43 is a storage device that stores and saves therein various programs, an OS, and data and operates as an internal disk of the management server 3.

The NIC 44 serves as a communication adapter that connects the management server 3 to, for example, an external network, such as the LAN 4. The NIC 44 is, for example, a LAN card.

As described below, the management server 3 issues, to the storage apparatus 10, a migration instruction (copy instruction) for migrating data from the storage apparatus 10 to the storage apparatus 20. After issuing the migration instruction, when a response indicating that the migration instruction is accepted is not properly returned from the storage apparatus 10, the management server 3 determines that the storage apparatus 10 does not support a data migration function according to the present embodiment and issues a migration instruction to the storage apparatus 20 instead.

The storage apparatuses 10 and 20 serve to provide the task server 2 with storage areas, and are connected to the task server 2 through the LAN and SAN to enable mutual communication. The storage apparatuses 10 and 20 are, for example, redundant array of independent disks (RAID) apparatuses.

The storage apparatus 10 includes a control module (CM) 11 and a drive enclosure (DE) 12.

The CM 11 includes a channel adaptor (CA) 13, a CPU 14, a RAM 15, a ROM 16, an HBA 17, and a disk adaptor (DA) 18.

The CA 13 is a module for providing connection between the task server 2 and the CM 11. The CA 13 provides connection between the task server 2 and the CM 11 by using various communication standards, such as Fibre Channel (FC), Internet Small Computer System Interface (iSCSI), Serial Attached SCSI (SAS), Fibre Channel over Ethernet (FCoE), and Infiniband.

The CPU 14 is a processing device that performs various types of control and various computational operations. The CPU 14 realizes various functions by executing programs stored in the ROM 16.

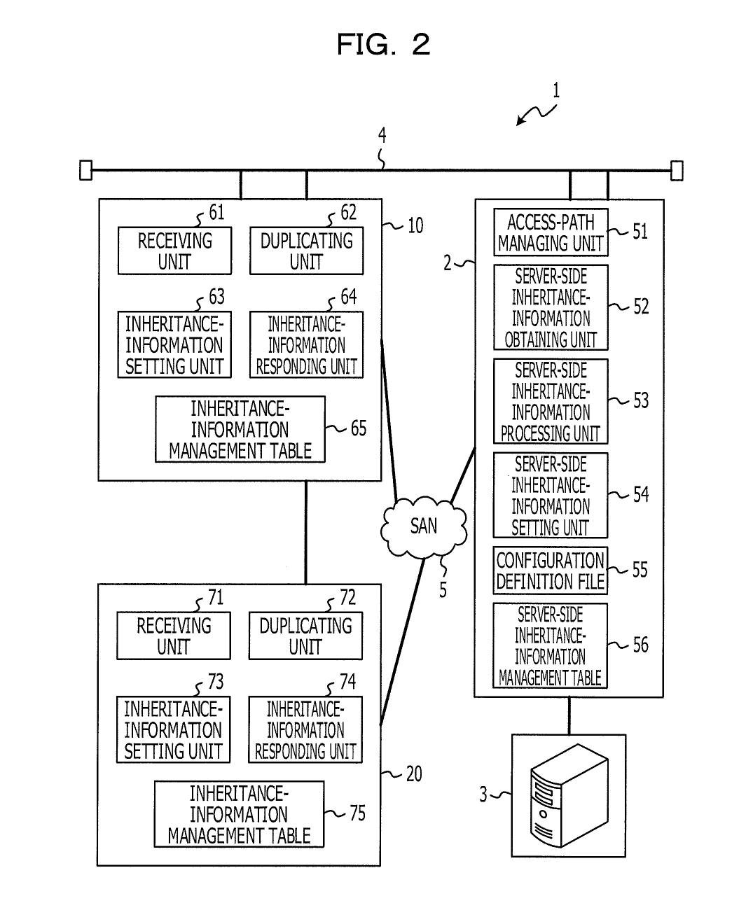

The RAM 15 stores therein programs executed by the CPU 14 and various types of data, as well as data resulting from operation of the CPU 14, and so on. The RAM 15 also serves as a storage unit that stores therein an inheritance-information management table 65 (see FIG. 2), which is described below.

The ROM 16 is a storage device that stores therein programs executed by the CPU 14 and various types of data.

The HBA 17 is a storage connection interface that connects to the task server 2 so as to allow communication therewith through the SAN 5. The HBA 17 is, for example, a Fibre Channel interface.

The DA 18 is an interface, such as an expander or an I/O controller (IOC), that connects the DE 12 (described below) and the CM 11 by, for example, SAS. The DA 18 controls data exchange with HDDs 19-1, 19-2, . . . , and 19-n (described below) included in the DE 12 (n is an integer greater than or equal to 1).

The elements, such as the CA 13 and the CPU 14 in the CM 11 and the DE 12, are interconnected through, for example, a Peripheral Component Interconnect Express (PCIe) bus.

The DE 12 includes the HDDs 19-1, 19-2, . . . , and 19-n.

The HDDs 19-1, 19-2, . . . , and 19-n are disk drives that provide storage areas. The storage apparatus 10 serves as logical volumes by combining the HDDs 19-1, 19-2, . . . , and 19-n.

Hereinafter, the HDDs are referred to as HDDs 19-1, 19-2, . . . , and 19-n to be individually specified, and an arbitrary one of the HDDs is referred to as an HDD 19.

The storage apparatus 20 includes a CM 21 and a DE 22.

The CM 21 includes a CA 23, a CPU 24, a RAM 25, a ROM 26, an HBA 27, and a DA 28.

The CA 23, the CPU 24, the RAM 25, the ROM 26, the HBA 27, and the DA 28 have functions and configurations that are the same as or similar to those of the CA 13, the CPU 14, the RAM 15, the ROM 16, the HBA 17, and the DA 18, respectively, in the storage apparatus 10.

The RAM 25 also serves as a storage unit that stores therein an inheritance-information management table 75 (see FIG. 2), which is described below.

The elements, such as the CA 23 and the CPU 24 in the CM 21 and the DE 22, are interconnected through, for example, a PCIe bus.

The DE 22 includes HDDs 29-1, 29-2, . . . , and 29-m (m is an integer greater than or equal to 1).

The HDDs 29-1, 29-2, . . . , and 29-m are disk drives that provide storage areas. The storage apparatus 20 serves as logical volumes by combining the HDDs 29-1, 29-2, . . . , and 29-m.

Hereinafter, the HDDs are referred to as HDDs 29-1, 29-2, . . . , and 29-m to be individually specified, and an arbitrary one of the HDDs is referred to as an HDD 29.

It is hereinafter assumed that the storage apparatus 10 is a storage apparatus from which data is migrated to the storage apparatus 20. Thus, in the following description, the storage apparatus 10 may be referred to as a “migration-source storage apparatus 10” or “migration-source storage 10”.

In addition, it is assumed that the storage apparatus 20 is a storage apparatus to which data is migrated from the storage apparatus 10. Thus, in the following description, the storage apparatus 20 may be referred to as a “migration-destination storage apparatus 20” or “migration-destination storage 20”

The term “migration” also refers to processing for storing a copy of entire data stored in volumes in the migration-source storage apparatus 10 into volumes in the migration-destination storage apparatus 20.

Disconnecting, after data in the migration-source storage apparatus 10 is migrated to the migration-destination storage apparatus 20, a cable connection between the migration-source storage apparatus 10 and the task server 2 and connecting the migration-destination storage apparatus 20 to the task server 2 may be referred to as “storage replacement”.

In addition, volumes in the storage apparatuses 10 and 20 may also be referred to hereinafter as “devices”. These volumes (devices) may be implemented by not only physical volumes (physical devices) but also logical volumes (logical devices), virtual volumes (virtual devices), and the like.

The functional configuration of the information processing system 1 will be described next.

FIG. 2 is a diagram illustrating the functional configuration of the information processing system 1 according to the first embodiment.

In FIG. 2, data in a volume in the migration-source storage apparatus 10 is copied to a volume in the migration-destination storage apparatus 20.

The task server 2 includes an access-path managing unit 51, a server-side inheritance-information obtaining unit 52, a server-side inheritance-information processing unit 53, a server-side inheritance-information setting unit 54, a configuration definition file 55, and a server-side inheritance-information management table 56.

During startup of the task server 2 or during update of recognized devices in the storage apparatuses 10 and 20, the access-path managing unit 51 issues an instruction for obtaining inheritance information to the server-side inheritance-information obtaining unit 52.

In response to the instruction, the server-side inheritance-information obtaining unit 52 issues a command (hereinafter referred to as an “inheritance-information obtaining command”) for obtaining the inheritance information to the storage apparatuses 10 and 20, to thereby obtain the inheritance information of the devices in the storage apparatuses 10 and 20.

The “inheritance information” as used herein refers to information for identifying the volumes in the storage apparatuses 10 and 20 between which data migration has been performed. The inheritance information includes inheritance-source information indicating a migration source of data and inheritance-destination information indicating a migration destination of the data.

In the present embodiment, on the task server 2, the inheritance information is managed in the server-side inheritance-information management table 56, and on the storage apparatuses 10 and 20, the inheritance information is managed in the inheritance-information management tables 65 and 75, respectively.

The server-side inheritance-information management table 56 contains inheritance information about not only the devices in the storage apparatuses 10 and 20 but also all devices connected to the task server 2.

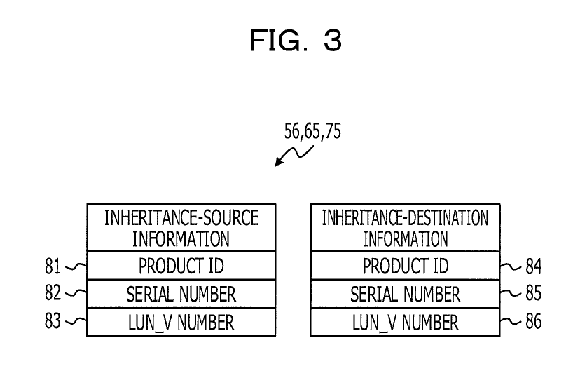

FIG. 3 illustrates exemplary structures of the server-side inheritance-information management table 56 and the inheritance-information management tables 65 and 75 used for managing the inheritance information.

In the examples in FIG. 3, the inheritance-source information has a product ID 81, a serial number 82, and a LUN_V number 83 as information indicating a volume in an inheritance source.

The LUN_V number 83 includes identification information that identifies the volume in the inheritance source. The LUN_V number 83 has, for example, a character string indicating a LUN of the inheritance source.

The product ID 81 has, for example, a character string indicating a product ID of the migration-source storage apparatus 10 to which the LUN registered as the LUN_V number 83 is assigned.

The serial number 82 has, for example, a character string indicating a serial number of the migration-source storage apparatus 10 to which the LUN registered as the LUN_V number 83 is assigned.

Similarly, the inheritance-destination information has a product ID 84, a serial number 85, and a LUN_V number 86 as information indicating a volume in an inheritance destination.

The LUN_V number 86 includes identification information that identifies the volume in the inheritance destination. The LUN_V number 86 has, for example, a character string indicating a LUN of the inheritance destination.

The product ID 84 has, for example, a character string indicating a product ID of the migration-destination storage apparatus 20 to which a LUN registered as the LUN_V number 86 is assigned.

The serial number 85 has, for example, a character string indicating a serial number of the migration-destination storage apparatus 20 to which the LUN registered as the LUN_V number 86 is assigned.

The server-side inheritance-information processing unit 53 compares the server-side inheritance-information management table 56 with the configuration definition file 55 to thereby determine whether or not storage replacement has been performed.

The server-side inheritance-information setting unit 54 generates a command (hereinafter referred to as an “inheritance-information setting command”) for setting the inheritance information and issues the inheritance-information setting command to the storage apparatuses 10 and 20. The inheritance-information setting command includes, for example, information (a product ID, a serial number, and a LUN_V number) indicating a device to be set, as well as setting values and setting descriptions of the device.

The configuration definition file 55 defines which of the storage apparatuses 10 and 20 and which of the HBAs are to be used and which access path is to be assigned to each device. The access-path managing unit 51 refers to the configuration definition file 55 to assign an access path to each device. The configuration definition file 55 includes, for example, path information as well as an apparatus type, a serial number, and a LUN_V number that are obtainable by a standard inquiry command. Since these properties (the apparatus type, the serial number, and the LUN_V number) are the same as the information included in the inheritance information, the server-side inheritance-information processing unit 53 may compare the inheritance information with the configuration definition file 55, as described above.

The storage apparatus 10 includes a receiving unit 61, a duplicating unit 62, an inheritance-information setting unit 63, and an inheritance-information responding unit 64, in addition to the inheritance-information management table 65.

The receiving unit 61 accepts a data migration instruction from the management server 3 and temporarily sets information, included in the data migration instruction, in the inheritance-information management table 65 (described below). In this case, for example, the receiving unit 61 turns off a flag (not illustrated) indicating that the inheritance-destination information is formally set. The term “temporary setting” refers to a state in which data is registered in the inheritance-information management table 65 but is not usable (not referable to) by the task server 2.

In accordance with the data migration instruction received from the management server 3, the duplicating unit 62 issues an instruction for copying data to the storage apparatus 20. When the copying is properly completed, the receiving unit 61 formally sets the contents of the data temporarily set in the inheritance-information management table 65. The “formal setting” refers to setting data registered and temporarily set in the inheritance-information management table 65 into a state in which the data is usable (referable to) by the task server 2. When the data is formally set, for example, the duplicating unit 62 turns on the flag (not illustrated) indicating that the inheritance-destination information is formally set.

The inheritance-information setting unit 63 accepts an inheritance-information setting command that is transmitted from the task server 2 in order to set the inheritance information and sets the information, included in the inheritance-information setting command, in the inheritance-information management table 65 (described below).

The inheritance-information responding unit 64 accepts an inheritance-information obtaining command that is transmitted from the task server 2 in order to obtain the inheritance information, and uses a target device, included in the inheritance-information obtaining command, as a key to scan the inheritance-information management table 65 to thereby obtain the inheritance information. After obtaining the inheritance information, the inheritance-information responding unit 64 transmits the inheritance information to the task server 2 as a response.

The inheritance-information management table 65 contains the inheritance information. Since the inheritance-information management table 65 has a structure that is analogous to the structure of the server-side inheritance-information management table 56 described above with reference to FIG. 3, a description thereof is not given.

The storage apparatus 20 includes a receiving unit 71, a duplicating unit 72, an inheritance-information setting unit 73, and an inheritance-information responding unit 74, in addition to the inheritance-information management table 75.

The receiving unit 71 accepts a copy instruction from the storage apparatus 10 and temporarily sets, in the inheritance-information management table 75, information included in the copy instruction. In this case, for example, the receiving unit 71 turns off a flag (not illustrated) indicating that the inheritance-source information is formally set. As described below, when the storage apparatus 10 does not support the data migration function according to the present embodiment, the receiving unit 71, instead of the storage apparatus 10, accepts a data migration instruction from the management server 3 and instructs the duplicating unit 72 to perform copying.

In accordance with the copy instruction received from the storage apparatus 10, the duplicating unit 72 copies data to a volume in the storage apparatus 20. When the copying is properly completed, the duplicating unit 72 formally sets the contents of the information temporarily set in the inheritance-information management table 75 by the receiving unit 71. In this case, the duplicating unit 72 turns on the flag (not illustrated) indicating that the inheritance-source information is formally set.

The inheritance-information setting unit 73 accepts an inheritance-information setting command from the task server 2 and sets the information, included in the inheritance-information setting command, in the inheritance-information management table 75 (described below).

The inheritance-information responding unit 74 accepts an inheritance-information obtaining command from the task server 2, and uses a target device, included in the inheritance-information obtaining command, as a key to scan the inheritance-information management table 75 to thereby obtain the inheritance information. After obtaining the inheritance information, the inheritance-information responding unit 74 transmits the inheritance information to the task server 2 as a response.

The inheritance-information management table 75 contains the inheritance information. Since the inheritance-information management table 75 has a structure that is analogous to the server-side inheritance-information management table 56 described above with reference to FIG. 3, a description thereof is not given.

In the first embodiment, by executing a data duplication program, the CPU 31 in the task server 2 is adapted to function as the access-path managing unit 51, the server-side inheritance-information obtaining unit 52, the server-side inheritance-information processing unit 53, and the server-side inheritance-information setting unit 54 described above.

The program (the data duplication program) for realizing the functions of the access-path managing unit 51, the server-side inheritance-information obtaining unit 52, the server-side inheritance-information processing unit 53, and the server-side inheritance-information setting unit 54 is recorded to a computer-readable recording medium and is supplied in the form thereof. Examples of the computer-readable recording medium include a flexible disk, a compact disk (CD), a digital versatile disk (DVD), a Blu-ray disc, a magnetic disk, an optical disk, and a magneto-optical disk. Examples of the CD include a CD-ROM, CD-R, and CD-RW, and examples of the DVD include a DVD-ROM, a DVD-RAM, a DVD-R, a DVD+R, a DVD-RW, a DVD+RW, and an HD DVD). The computer reads the program from the recording medium, transfers the program to the internal storage device (in the present embodiment, the RAM 32 or ROM in the task server 2) or an external storage device, stores the program therein, and uses the program. The program may also be recorded to, for example, a recording medium in a storage device, such as a magnetic disk, an optical disk, or a magneto-optical disk, and be supplied from the storage device to the computer through a communication link.

A microprocessor (in the present embodiment, the CPU 31) in the computer (the task server 2) executes the program stored in the internal storage device to realize the functions of the access-path managing unit 51, the server-side inheritance-information obtaining unit 52, the server-side inheritance-information processing unit 53, and the server-side inheritance-information setting unit 54 described above. In this case, the computer may read the program recorded on the recording medium and execute the read program.

The CPUs 14 and 24 in the storage apparatuses 10 and 20 execute a data duplication program to thereby function as the receiving units 61 and 71, the duplicating units 62 and 72, the inheritance-information setting units 63 and 73, and the inheritance-information responding units 64 and 74, respectively.

The program (the data duplication program) for realizing the functions of the receiving units 61 and 71, the duplicating units 62 and 72, the inheritance-information setting units 63 and 73, and the inheritance-information responding units 64 and 74 is recorded to a computer-readable recording medium and is supplied in the form thereof. Examples of the computer-readable recording medium include a flexible disk, a CD (such as a CD-ROM, CD-R, or CD-RW), a DVD (such as a DVD-ROM, DVD-RAM, DVD-R, DVD+R, DVD-RW, DVD+RW, or HD DVD), a Blu-ray disc, a magnetic disk, an optical disk, or a magneto-optical disk. The computer reads the program from the recording medium, transfers the program to the internal storage device (in the present embodiment, the RAMs 15 and 25 or the ROMs 16 and 26 in the storage apparatuses 10 and 20) or an external storage device, stores the program therein, and uses the program. The program may also be recorded to, for example, a recording medium in a storage device, such as a magnetic disk, an optical disk, or a magneto-optical disk, and be supplied from the storage device to the computer through a communication path.

Microprocessors (in the present embodiment, the CPUs 14 and 24) in the computers (the storage apparatuses 10 and 20) execute the program stored in the internal storage devices to thereby realize the functions of the inheritance-information setting units 63 and 73 and the inheritance-information responding units 64 and 74, respectively. In this case, the computer may read the program recorded on the recording medium and execute the read program.

The term “computer” in the present embodiment refers to a concept including hardware and an OS and means hardware that operates under the control of the OS. When the hardware is operable with an application program alone without use of the OS, the hardware itself corresponds to the computer. The hardware has at least a microprocessor, such as a CPU, and a mechanism for reading a computer program recorded on a recording medium. In the present embodiment, the management server 3 and the CMs 11 and 21 have functions of the computer.

Operation

Operations of the information processing system 1 according to the first embodiment will be described next.

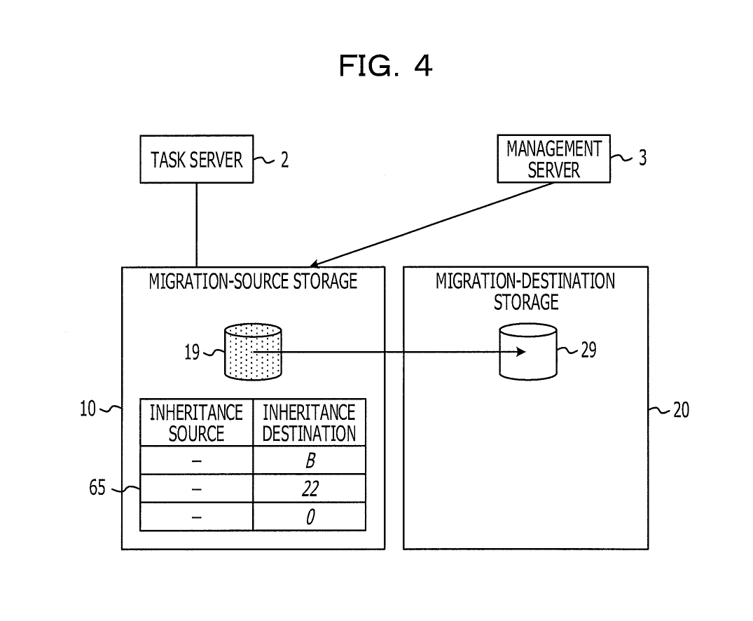

FIGS. 4 to 8 illustrate operations during storage replacement in the information processing system 1 according to the first embodiment. In the example described below, it is assumed that the product ID of a volume in the migration-source storage apparatus 10 is “A”, the serial number of the volume is “11”, and the LUN of the volume is “0”. It is also assumed that the product ID of a volume in the migration-destination storage apparatus 20 is “B”, the serial number of the volume is “22”, and the LUN of the volume is “0”.

In this case, Phase_{—}1 to Phase_{—}6 described below are executed.

(Phase_{—}1) First, as illustrated in FIG. 4, the management server 3 transmits a migration command to the migration-source storage apparatus 10 to instruct the migration-source storage apparatus 10 to copy (that is, migrate) data from the migration-source storage apparatus 10 to the migration-destination storage apparatus 20. The migration command includes migration-source information about the migration-source storage apparatus 10 and migration-destination information about the migration-destination storage apparatus 20. The migration-source information includes a product identifier (PID), a serial number, and a LUN_V number of the migration-source storage apparatus 10. The migration-destination information includes a PID, a serial number, and a LUN_V number of the migration-destination storage apparatus 20. Those pieces of information are specified during storage replacement by, for example, an operator who uses the management server 3.

The receiving unit 61 in the migration-source storage apparatus 10 receives the migration command from the management server 3 and starts processing for copying data to the volume in the migration-destination storage apparatus 20.

The receiving unit 61 in the migration-source storage apparatus 10 extracts the migration-source information and the migration-destination information included in the migration command, and stores the migration-source information and the migration-destination information in the inheritance-information management table 65 as inheritance-source information and inheritance-destination information, respectively. At this point in time, however, the migration-source information and the migration-destination information are still registered as temporary information (in FIG. 4, the temporary information is indicated in oblique type). In this case, for example, the receiving unit 61 turns off the flag (not illustrated) indicating that the inheritance-destination information is formally set.

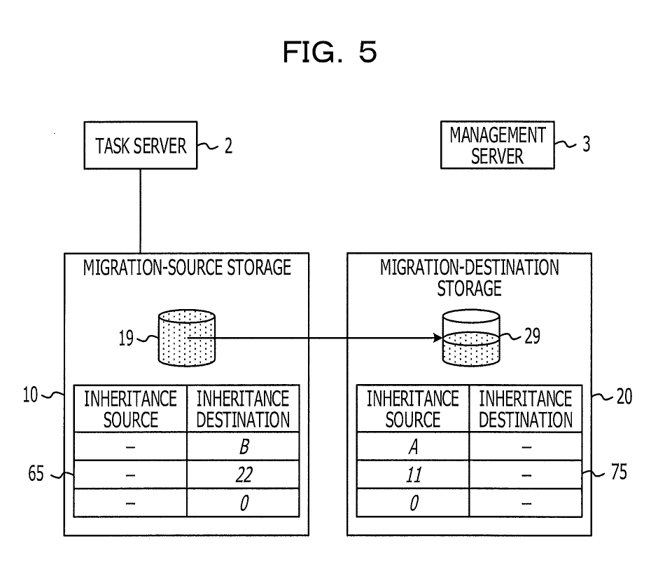

(Phase_{—}2) Next, as illustrated in FIG. 5, the receiving unit 71 in the migration-destination storage apparatus 20 accepts copy processing from the migration-source storage apparatus 10 and stores the migration-source information and the migration-destination information in the inheritance-information management table 75. At this point in time, however, the migration-source information and the migration-destination information are still registered as temporary information (in FIG. 5, the temporary information is indicated in oblique type). In this case, for example, the receiving unit 71 turns off the flag (not illustrated) indicating that the inheritance-source information is formally set.

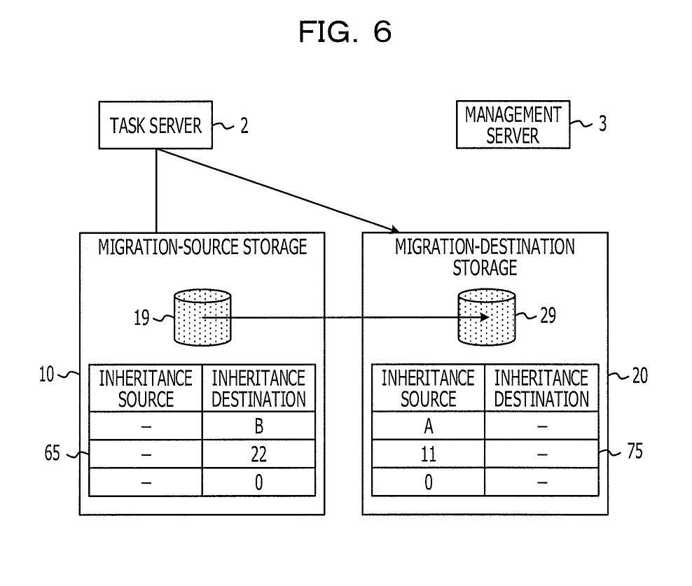

(Phase_{—}3) Next, copying of the data between the storage apparatuses 10 and 20 is completed as illustrated in FIG. 6. At this point in time, the duplicating units 62 and 72 in the storage apparatuses 10 and 20 register the inheritance-destination information and the inheritance-source information as formal information (in FIG. 6, the formal information is indicated in normal type). In this case, for example, the receiving unit 61 turns on the flag (not illustrated) indicating that the inheritance-source information is formally set.

After the inheritance-source information and the inheritance-destination information are formally registered in the inheritance-information management tables 65 and 75 in the storage apparatuses 10 and 20 as formal information, the task server 2 may refer to the inheritance-source information and the inheritance-destination information.

(Phase_{—}4) The migration-destination storage apparatus 20 and the task server 2 are interconnected using a cable (not illustrated).

The cable connection triggers device recognition processing. Upon starting the device recognition processing, the server-side inheritance-information obtaining unit 52 in the task server 2 issues an inheritance-information obtaining command to all recognized devices to obtain the inheritance information of the devices.

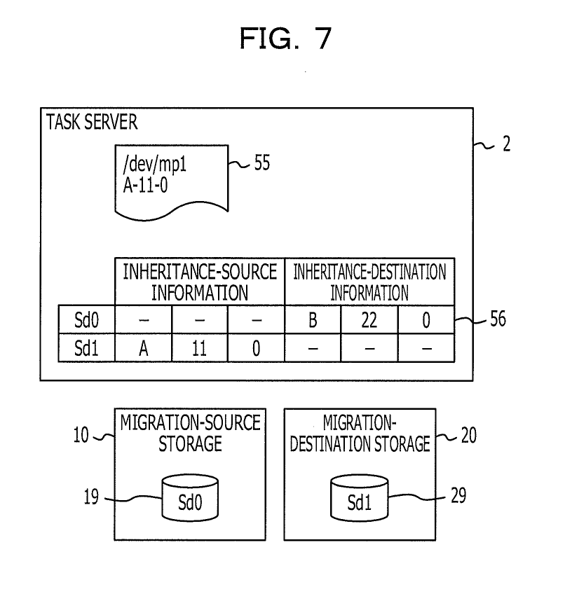

(Phase_{—}5) Next, as illustrated in FIG. 7, the server-side inheritance-information processing unit 53 in the task server 2 determines whether or not storage replacement has been performed.

More specifically, the server-side inheritance-information processing unit 53 compares the inheritance information of the devices in the migration-destination storage apparatus 20, which has been obtained by the server-side inheritance-information obtaining unit 52 in Phase_{—}4, with the configuration definition file 55. When the device information listed in the configuration definition file 55 matches the obtained inheritance-source information for each of the devices in the migration-destination storage apparatus 20, this means that storage replacement has been performed. In an example in FIG. 7, the inheritance-source information for a migration-destination device Sd1 is “A-11-0”, and this device Sd1 is defined in the configuration definition file 55 as an access path “/dev/mp1”. This indicates that the access path “/dev/mp1” is to be assigned to the device Sd1 in the storage apparatus 20 illustrated in FIG. 7.

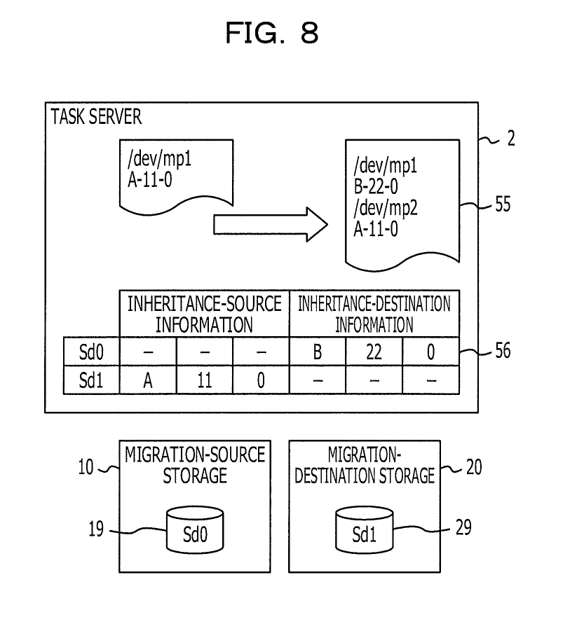

(Phase_{—}6) Next, as illustrated in FIG. 8, from among the devices recognized by the task server 2, a device having the inheritance-destination information obtained by the server-side inheritance-information obtaining unit 52 in Phase_{—}4 is checked. Since a device having the inheritance-destination information corresponds to a migration-source volume, an access path having a name that does not overlap any existing path is assigned to the device. For instance, in an example in FIG. 8, a device “A-11-0” having the inheritance-destination information corresponds to a migration-source volume, and an access path, for example, “/dev/mp2”, that does not overlap any existing path is assigned to the device.

When it is determined in Phase_{—}5 described above that storage replacement has been performed, the task server 2 waits for completion of processing for all I/O requests that have issued to the migration-source storage apparatus 10 and temporarily queues, in the access-path managing unit 51, I/O requests to be issued from the task server 2. While the I/O requests are queued, the access-path managing unit 51 updates the configuration definition file 55 and assigns an access path to each device based on the updated configuration definition file 55.

Thereafter, the task server 2 dequeues the I/O requests.

In Phase_{—}1 to Phase_{—}6, the access path is non-disruptively re-assigned as described above. As illustrated in FIG. 8, the task server 2 may continue a task with the migration-destination device Sd1 by using the access path “/dev/mp1” that is the same as the access path before the migration.

In storage replacement, it is also important to be able to quickly fall back to a pre-migration state in the event of trouble after migration (this fallback operation is herein referred to as “storage fallback”). Such storage fallback may be performed using the inheritance-destination information.

In such a case, for example, the storage fallback may be performed according to the following procedure.

An operator stops the operation of the task server 2 to disconnect the cable connection (wire connection) between the task server 2 and the migration-destination storage apparatus 20.

Next, the operator starts up the task server 2.

In device recognition processing in a boot sequence, the access-path managing unit 51 in the task server 2 obtains inheritance information for recognized devices.

The access-path managing unit 51 then determines whether or not storage fallback has been performed. For example, when inheritance-destination information of a device is listed in the configuration definition file 55 and this device listed in the configuration definition file 55 is not connected to the task server 2, the access-path managing unit 51 determines that storage fallback has been performed.

Upon determining that storage fallback has been performed, the access-path managing unit 51 updates the configuration definition file 55 to assign an access path to a device in the migration-source storage apparatus 10, the access path being the same as an access path originally assigned to the device. For example, in the examples in FIGS. 7 and 8, the access path “/dev/mp1” originally assigned to the device Sd0 in the migration-source storage apparatus 10 is assigned to the device Sd0.

The task server 2 then starts a task using the migration-source storage apparatus 10.

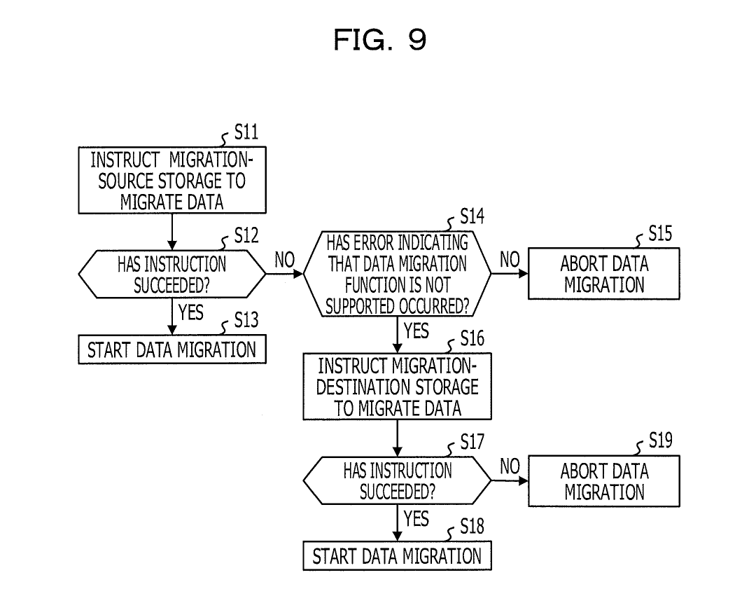

Next, operations of the task server 2, the management server 3, and the storage apparatuses 10 and 20 in the information processing system 1 will be described with reference to FIGS. 9 to 11.

First, operations of the management server 3 will be described with reference to a flowchart in FIG. 9.

FIG. 9 is a flowchart illustrating operations of the management server 3 according to the first embodiment.

In S11, the management server 3 transmits a migration command to the migration-source storage apparatus 10 to instruct the migration-source storage apparatus 10 to migrate data.

In S12, the management server 3 determines whether or not the data migration instruction to the migration-source storage apparatus 10 has succeeded. In this case, for example, the management server 3 determines whether or not a response indicating that the data migration instruction has been properly accepted is returned from the migration-source storage apparatus 10.

When the data migration instruction to the migration-source storage apparatus 10 has succeeded (“YES” in S12), the management server 3 starts data migration in S13.

On the other hand, when the data migration instruction to the migration-source storage apparatus 10 fails (“NO” in S12), the process proceeds to S14 in which the management server 3 determines whether or not an error indicating that the data migration function is not supported has occurred. In this case, for example, when a response from the migration-source storage apparatus 10 is not returned within a timeout period or when a response from the migration-source storage apparatus 10 indicates information other than “properly accepted”, the management server 3 determines that an error indicating that the data migration function is not supported has occurred.

When an error other than an error indicating that the data migration function is not supported has occurred (“NO” in S14), the management server 3 aborts the data migration in S15.

When an error indicating that the data migration function is not supported has occurred (“YES” in S14), the process proceeds to S16 in which the management server 3 transmits a migration command to the migration-destination storage apparatus 20 to instruct the migration-destination storage apparatus 20 to migrate data.

Next, in S17, the management server 3 determines whether or not the data migration instruction to the migration-destination storage apparatus 20 has succeeded. In this case, for example, the management server 3 determines whether or not a response indicating “properly accepted” is returned from the migration-destination storage apparatus 20.

When the data migration instruction to the migration-destination storage apparatus 20 has succeeded (“YES” in S17), the management server 3 starts data migration in S18.

On the other hand, when the data migration instruction to the migration-destination storage apparatus 20 fails (“NO” in S17), the management server 3 aborts the data migration in S19.

As described above, the migration-source storage apparatus 10 and the migration-destination storage apparatus 20 have two types of inheritance information, that is, the inheritance-source information and the inheritance-destination information. With this arrangement, even when only one of the storage apparatuses 10 and 20 supports the data migration function according to the present embodiment, it is possible to ensure that the access path name is maintained between before and after storage replacement.

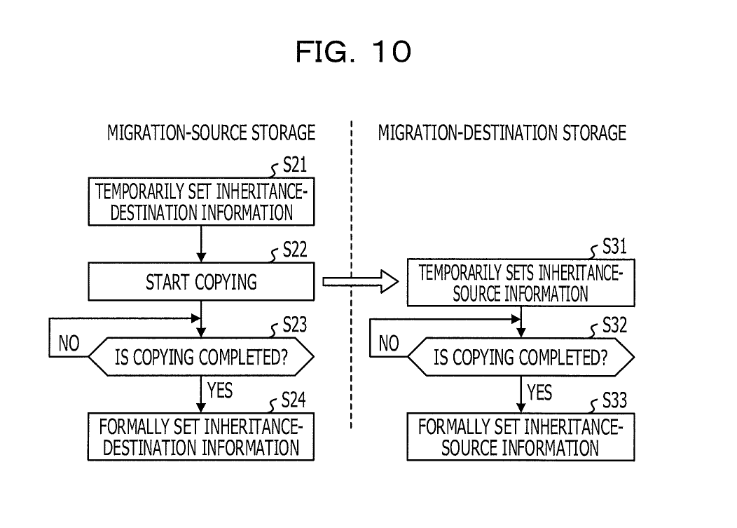

Next, operations of the storage apparatuses 10 and 20 will be described with reference to FIG. 10.

FIG. 10 is a flowchart illustrating operations of the storage apparatuses 10 and 20 according to the first embodiment.

In S21, the receiving unit 61 in the migration-source storage apparatus 10 accepts the data migration instruction from the management server 3 (see S11 in FIG. 9) and temporarily sets the inheritance-destination information in the inheritance-information management table 65 (see FIG. 4: Phase_{—}1).

Next, in S22, the duplicating unit 62 in the migration-source storage apparatus 10 starts copying to the migration-destination storage apparatus 20.

When copying to the migration-destination storage apparatus 20 is started, the process proceeds to S31 in which the receiving unit 71 in the migration-destination storage apparatus 20 accepts a copy instruction from the migration-source storage apparatus 10 and temporarily sets the inheritance-source information in the inheritance-information management table 75 (see FIG. 5: Phase_{—}2).

Next, in S23, the duplicating unit 62 in the migration-source storage apparatus 10 determines whether or not the copying to the migration-destination storage apparatus 20 is completed.

When it is determined in S23 that the copying is not completed (“NO” in S23), the process returns to S23.

On the other hand, when it is determined in S23 that the copying is completed (“YES” in S23), the duplicating unit 62 in the migration-source storage apparatus 10 formally sets the inheritance-destination information in the inheritance-information management table 65 in S24 (see FIG. 6: Phase_{—}3).

In parallel with S23, in S32, the duplicating unit 72 in the migration-destination storage apparatus 20 determines whether or not the copying to the migration-destination storage apparatus 20 is completed.

When it is determined in S32 that the copying is not completed (“NO” in S32), the process returns to S32.

On the other hand, when it is determined in S32 that the copying is completed (“YES” in S32), the duplicating unit 72 in the migration-destination storage apparatus 20 formally sets the inheritance-source information in the inheritance-information management table 75 in S33 (see FIG. 6).

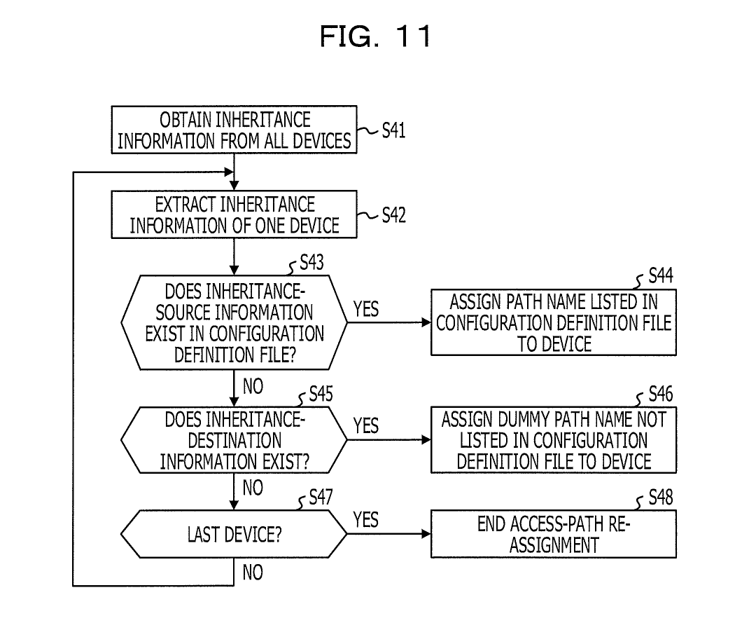

Next, the operation of the task server 2 will be described with reference to FIG. 11.

FIG. 11 is a flowchart illustrating operations of the task server 2 according to the first embodiment.

In S41, the server-side inheritance-information obtaining unit 52 in the task server 2 issues an inheritance-information obtaining command to all devices to obtain inheritance information therefrom.

In S42, the server-side inheritance-information processing unit 53 extracts the inheritance information of one device from the inheritance information obtained by the server-side inheritance-information obtaining unit 52 in S41.

In S43, with respect to the device whose inheritance information has been extracted in S42, the server-side inheritance-information processing unit 53 determines whether or not the inheritance-source information in the inheritance information exists in the configuration definition file 55.

When the inheritance-source information exists in the configuration definition file 55 (“YES” in S43), the process proceeds to S44 in which the access-path managing unit 51 assigns a path name listed in the configuration definition file 55 to the device.

On the other hand, when the inheritance-source information does not exist in the configuration definition file 55 (“NO” in S43), the process proceeds to S45 in which the server-side inheritance-information processing unit 53 determines whether or not the inheritance-destination information for the device exists in the configuration definition file 55.

When the inheritance-destination information exists in the configuration definition file 55 (“YES” in S45), the process proceeds to S46 in which the access-path managing unit 51 assigns a dummy path name not listed in the configuration definition file 55 to the device (see FIG. 8).

On the other hand, when the inheritance-destination information does not exist in the configuration definition file 55 (“NO” in S45), the process proceeds to S47 in which a determination is made as to whether or not the device whose inheritance information has been extracted in S42 is a last device whose inheritance information has been obtained by the server-side inheritance-information obtaining unit 52 in S41.

When the device is not the last device (“NO” in S47), the process returns to S42 in which the inheritance information of a next device is extracted.

On the other hand, when the device is the last device (“YES” in S47), the access-path managing unit 51 ends re-assignment of access path in S48.

As described above, the migration-source storage apparatus 10 and the migration-destination storage apparatus 20 have two types of inheritance information, that is, the inheritance-source information and the inheritance-destination information. With this arrangement, even when only one of the storage apparatuses 10 and 20 supports the data migration function, it is possible to ensure that the access path name is maintained between before and after storage replacement.

Now, a description will be given of an operation in a case in which the storage apparatus 10 does not support the data migration function.

As described above, the management server 3 issues a data migration instruction to the migration-destination storage apparatus 20 instead of the migration-source storage apparatus 10. Upon accepting the data migration instruction, the migration-destination storage apparatus 20 starts copying and stores information in the inheritance-information management table 75.

Thereafter, the user connects a cable between the task server 2 and the migration-destination storage apparatus 20.

When the cable is connected, device recognition is executed during which the task server 2 attempts to obtain the inheritance information from all recognized devices. In this case, it is assumed that the task server 2 may obtain the inheritance information from only the migration-destination storage apparatus 20.

With respect to a device (in this example, a device in the storage apparatus 10) whose inheritance information has not been successfully obtained, the task server 2 uses an inquiry command to obtain the PID, the serial number, and the LUN_V number of the device.

The access-path managing unit 51 checks the obtained inheritance-source information to check whether or not a condition is satisfied. The condition is that the inheritance-source information of the device is listed in the configuration definition file 55 and also a device having the information listed in the configuration definition file 55 is recognized.

When the condition is satisfied, the access-path managing unit 51 updates the configuration definition file 55. Thus, an access path name originally assigned to the storage apparatus 10 may be assigned to the new storage apparatus 20.

Advantages

As described above, according to the present embodiment, the inheritance information is stored in the storage apparatuses 10 and 20, and the task server 2 obtains the inheritance information in the storage apparatuses 10 and 20 during device recognition and updates the configuration definition file 55 in the task server 2 on the basis of the obtained inheritance information. With this arrangement, when the storage apparatus 10 in operation is replaced with the storage apparatus 20, the task server 2 may access the storage apparatus 20 after migration without the user manually changing the settings of access path, suspending a task, or installing a dedicated apparatus.

In addition, since two types of inheritance information, that is, the inheritance-source information and the inheritance-destination information are stored, it is possible to fall back to the storage apparatus 10.

Even when one of the storage apparatuses 10 and 20 does not support the data migration function, it is also possible to migrate data. Thus, it is possible to perform storage replacement even in a system environment in which new and old storage apparatuses 10 and 20 coexist.

### Other Embodiments

Embodiments are not limited to the above-described embodiment, and various changes and modifications may be made thereto without departing from the spirit and scope thereof.

For example, although the task server 2 and the management server 3 are prepared independently from each other in the first embodiment described above, the functions of the management server 3 may also be incorporated into the task server 2.

In addition, although a product ID, a serial number, and a LUN_V number are used as the inheritance information in the first embodiment described above, other information may also be used. The inheritance information may also have information with which a determination may be made that storage replacement has been performed, for example, when the port position of the HBA is changed or when any of other various events occurs. In such a case, it is possible to ensure the access path name is maintained between before and after storage replacement.

Although the inheritance-information obtaining command is a newly defined vendor-unique command in the first embodiment, the inheritance-information obtaining command may be an existing command. For example, by using a vendor-unique field in an inquiry command, the inquiry command may also be used as the inheritance-information obtaining command.

In the first embodiment, the task server 2 operates non-disruptively. However, the operation of the task server 2 may be stopped, or only I/O accesses from the task server 2 may be stopped. In this case, in order to replace access path by updating the configuration definition file 55 in the task server 2, a specific sense code may be returned from the migration-destination storage apparatus 20 to trigger the replacement of the access path or a resident daemon may periodically update the access path.

Although a case in which the cable is connected between the migration-destination storage apparatus 20 and the task server 2 after copying is completed has been described in the first embodiment, the cable may be connected before the copying is executed. In such a case, a sense code indicating that the copying is completed may be returned to the access-path managing unit 51 after the copying is completed, and in response to the sense code, the access-path managing unit 51 may perform processing for re-assigning access path.

Although an access path is described as an example of the information inherited during storage replacement in the first embodiment, the present technology may also be used to inherit other information, such as a maximum throttle value in a Fibre Channel driver layer. For example, entries for such other information are provided in the inheritance-source information and the inheritance-destination information, and when inheritance information is set, corresponding parameters are also set in the entries. Subsequently, after the task server 2 reads the inheritance information, the values of the inheritance information may also be updated during re-assignment of the access path.

Although a case in which data in one volume is migrated is described in the first embodiment, data in multiple volumes may also be migrated at the same time. In such a case, entries for the inheritance information in the storage apparatuses 10 and 20 are prepared for respective LUNs. Arbitrary volume names are also assigned to multiple migration-source volumes. For example, employing mutual exclusion to manage a counter for automatic numbering of volume names makes it possible to assign an access path having a unique name to each migration-source volume.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
an information processing apparatus;
a first storage apparatus; and
a second storage apparatus,
wherein
the first storage apparatus includes
a first processor configured to
receive, from the information processing apparatus, a first migration command for migrating data from the first storage apparatus to the second storage apparatus,
create inheritance-destination information based on the first migration command,
instruct the second storage apparatus to create inheritance-source information based on the first migration command, and
perform migration of the data in accordance with the first migration command, and
the information processing apparatus includes
a second processor configured to
obtain the inheritance-destination information and the inheritance-source information from at least one of the first storage apparatus and the second storage apparatus,
determine whether migration of the data from the first storage apparatus to the second storage apparatus has been performed, and
assign, based on the inheritance-destination information and the inheritance-source information, an access path to the second storage apparatus upon determining that migration of the data has been performed.

2. The information processing system according to claim 1, wherein the first processor is configured to
receive, from the information processing apparatus, an obtaining command for obtaining the inheritance-destination information and the inheritance-source information, and
transmit the inheritance-destination information and the inheritance-source information in accordance with the received obtaining command.

3. The information processing system according to claim 1, wherein
the second processor is configured to
transmit, when the first storage apparatus does not properly receive the first migration command, to the second storage apparatus a second migration command for migrating the data from the first storage apparatus to the second storage apparatus, and
the second storage apparatus includes
a third processor configured to
receive the second migration command from the information processing apparatus,
create the inheritance-destination information and the inheritance-source information based on the second migration command, and
perform migration of the data in accordance with the second migration command.

4. The information processing system according to claim 1, wherein
the first processor is configured to
receive, from the information processing apparatus, a setting command for setting the inheritance-destination information and the inheritance-source information, and
set the inheritance-destination information and the inheritance-source information in accordance with the received setting command.

5. A storage apparatus comprising:
a processor configured to
receive a migration command for migrating data from the storage apparatus to a destination storage apparatus,
create inheritance-destination information based on the migration command,
instruct the destination storage apparatus to create inheritance-source information based on the migration command, and
perform migration of the data in accordance with the migration command.

6. The storage apparatus according to claim 5, wherein
the processor is configured to
receive an obtaining command for obtaining the inheritance-destination information and the inheritance-source information, and
transmit the inheritance-destination information and the inheritance-source information in accordance with the received obtaining command.

7. The storage apparatus according to claim 5, wherein
the processor is configured to
receive a setting command for setting the inheritance-destination information and the inheritance-source information, and
set the inheritance-destination information and the inheritance-source information in accordance with the received setting command.

8. A method for migrating data, the method comprising:
transmitting, by an information processing apparatus, to a first storage apparatus a first migration command for migrating data from the first storage apparatus to a second storage apparatus;
creating, by the first storage apparatus, inheritance-destination information based on the first migration command;
instructing, by the first storage apparatus, the second storage apparatus to create inheritance-source information based on the first migration command;
performing, by the first storage apparatus, migration of the data in accordance with the first migration command;
obtaining, by the information processing apparatus, the inheritance-destination information and the inheritance-source information from at least one of the first storage apparatus and the second storage apparatus;
determining, by the information processing apparatus, whether migration of the data from the first storage apparatus to the second storage apparatus has been performed; and
assigning, by the information processing apparatus, an access path to the second storage apparatus based on the inheritance-destination information and the inheritance-source information upon determining that migration of the data has been performed.

9. The method according to claim 8, further comprising:
transmitting by the information processing apparatus, when the first storage apparatus does not properly receive the first migration command, to the second storage apparatus a second migration command for migrating the data from the first storage apparatus to the second storage apparatus;
creating, by the second storage apparatus, the inheritance-destination information and the inheritance-source information based on the second migration command; and
performing, by the second storage apparatus, migration of the data in accordance with the second migration command.
